(19) United States
(12) Patent Application Publication
(10) Pub. No.: US 2001/0045396 A1
(43) Pub. Date: Nov. 29, 2001

(54) Physicochemical method of oxygen scavenging in boiler feedwaters

(76) Inventor: John Charles White, Beaumont, TX (US)

Correspondence Address: JOHN CHARLES WHITE, P.O. BOX 13030, BEAUMONT, TX, 77726, US

(21) Appl. No.: 09/860,084

(22) Filed: May 17, 2001

Related U.S. Application Data
(60) Provisional application No. 60/206,117, filed on May 22, 2000.

(51) Int. Cl. C02F 1/66

(52) U.S. Cl. 210/743; 210/750

(57) ABSTRACT

Oxygen scavenging with sulfites in boilerwater systems is dependant upon variable interrelated opposing kinetic relationships of ph, transitional catalyst properties and the ratio of bisulfite specie and sulfite specie that will vary between ph 4.5 and 9.0. The sulfite specie, SOsub.3, is formed as the preferential reactant with oxygen, FIG. 2. The oxygen sulfite reaction is second order with respect to sulfite concentrations within boilers. The sulfite specie is 100% favored at ph 8.5 to 9.0. Cobalt is a transitional catalyst that affects an oxygen sulfite reaction directly proportionally to the square root of cobalt's solution concentration but it precipitates at or above ph 8.5, or is complexed in boilerwater by chelants, or is inhibited in boilerwater by amines, or precipitated as its hydroxide by boilerwater alkalinity. Under prior art, these adverse conditions affecting the catalytic activity of cobalt or other metal ions have not been addressed. Boilerwater chemistries are inherently inhibitory and cannot be varied to accommodate cobalt catalysis, nor ph required to maximize kinetic relationships. Sulfites are relatively ineffective at ph ranges above 10.38 in absence of catalysts. The deaerator, FIG. 1, permits a means whereby variables are controlled by integrated automated physicochemical responses for controlled stoichiometry between sulfite and oxygen utilizing electrical sensing equipment. This is accomplished before oxygen can enter boilers where, in the past, high sulfite residuals could decompose into sulphides at pressures above 900 psig. Higher Sulfite residuals within boilerwater will no longer be required as a main line of defense against oxygen attack.

I claim priority under provisional application No. 60/206,117 of May 22, 2000.

### BACKGROUND OF THE INVENTION

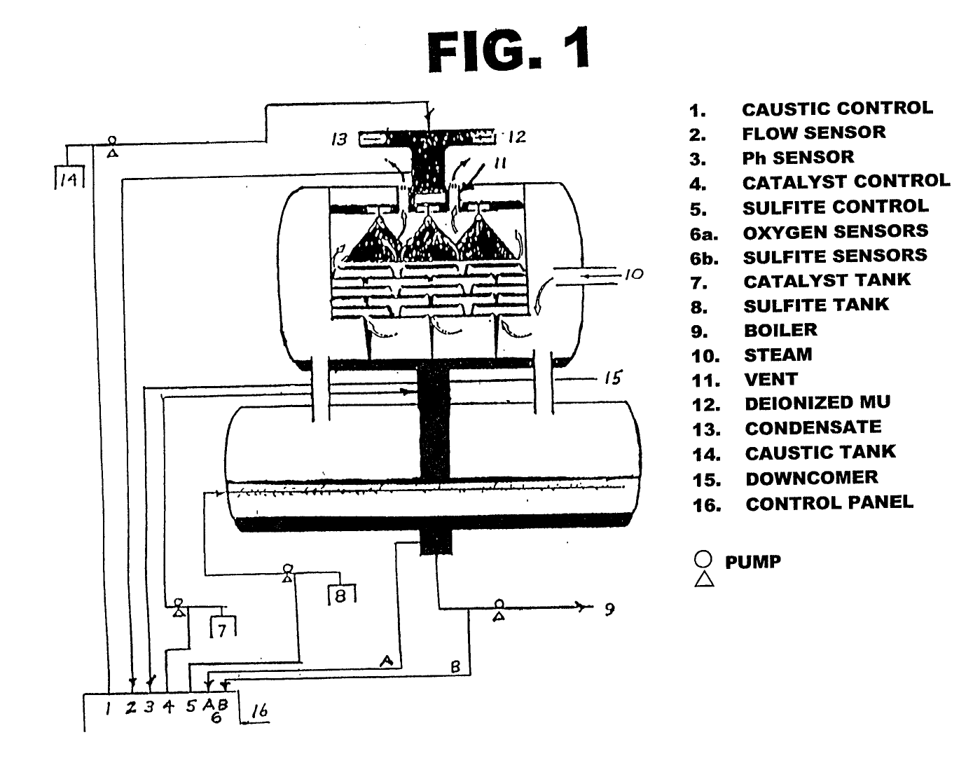

FIG. 1; Flow illustration of a typical deaerator spray/scrubber with storage water section.

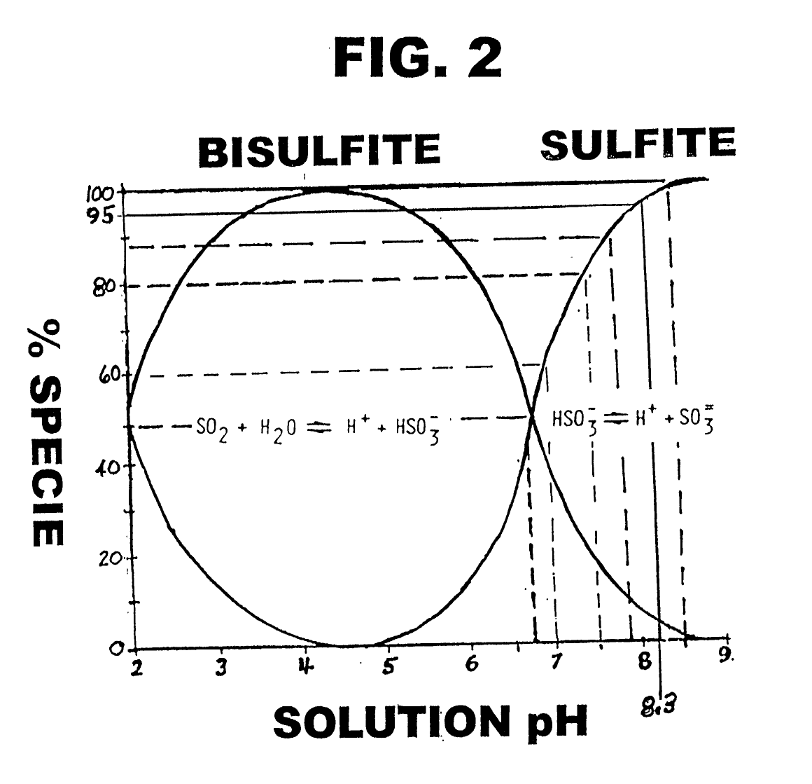

FIG. 2; Curves illustrating specie shifts from bisulfite to sulfite with increasing solution ph.

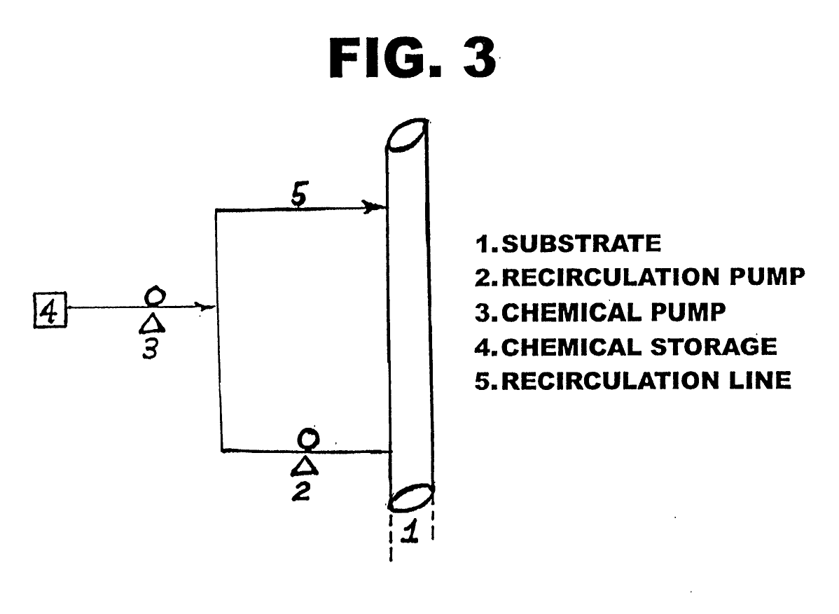

FIG. 3; Schematic of chemical feeding with recirculation of substrate.

Boiler feedwater is a principle source of oxygen contamination in boilers, ref. 1. Dissolved oxygen is objectionable because it is the prime corrodent of preboiler and boiler equipment.

Boiler feedwater is a blend of condensate from earlier steam generation and fresh makeup water. This blended water is fed into a common header or mixing T of a deaerator where a deaerator removes oxygen by physical action.

Deaerators are designed within limits of hydraulic flows and the gas laws of Henry and Boyle. Deaerators are designed to produce an effluent water having oxygen content no greater than 7 ppb, parts per billion.

Serious copper deposition problems can occur even when oxygen levels are kept below 7 ppb limits, typical of mechanical deaeration, ref. 23.

Incomplete deaeration occurs when; 1. Sprays malfunction, 2. Trays are misaligned or absent, 3. Temperatures between heater section and storage section deviate from specification, 4. Inadequate venting occurs, etc.

Corrosion of steam generator system materials are estimated to be a logarithmic function of oxygen concentration. This means that a benefit achievable through reduction of oxygen concentration from 100 ppb to 10 ppb is equal to the benefit from a reduction of 1000 ppb to 100 ppb. There is a consistent relationship between turbine disc cracking with boiler feedwater oxygen concentrations above 20 ppb, ref. 2.

Oxygen is relatively 5 to 10 times more active in causing failures of return line piping than equal concentrations of carbon dioxide and 10 to 40 percent higher than the sum of corrosive damage produced when each gas acts independently, ref. 3.

Description of Prior Art

Methods of applying sodium sulfite and sodium bisulfite have been unchanged since their generally accepted use began about 1913. Both catalyzed and non catalyzed specie have been fed directly into boilers or pre boiler equipment with an expectation of oxygen scavenging from that given feed point forward through a boiler where concentrations increase as a result of evaporation.

Generally, a chosen feed point for either specie is the storage section of deaerators where the ph from demineralized makeup water is less than 7.0. In one instance, caustic was added to raise the ph to 9.0 prior to a deaerator for corrosion control, ref. 6. However, there is no evidence that deaerator water has been specifically controlled between the exacting ph level 7.8 to 8.5 for optimum catalytic benefits of both cobalt and the only oxygen reactive specie, SOsub.3. The bisulfite specie is non-reactive, ref. 9, 18.

Deaerators feed water to economizers that feed water to boilers. A study reported oxygen present in a preboiler economizer that contained 2.6 ppm, parts per million, of sulfite, ref. 7. Consultants have specified as much as 100-140 ppm sodium sulfite residuals in a high pressure boiler, ref. 8.

A number of researchers have confirmed the oxygen sulfite reaction to be second order. The reaction is dependent upon the concentration of sulfite specie, among other factors, and independent of oxygen concentration except when oxygen concentrations fall to the level of 800 ppb where oxygen becomes limiting, as is the case within deaerators, ref. 9. Concentrations of sulfite increase within boilers as water is evaporated into steam. This increased sulfite concentration is a preemptive method of defending against oxygen intrusions.

However, sulfites are less reactive when catalysis is inhibited within boilerwater. Oxygen has the capacity to channel through boilerwater and flash into condensate systems under sulfite inhibiting conditions, ref. 9, 10, 12, 13, 14, 15.

Common boilerwater additives, like amines and chelants, indirectly affect the oxygen sulfite reaction rate by forming complexes with catalytic ions to inhibit or eliminate catalyst concentrations, ref. 1, 5, 13,15,16.

In the presence of catalysts, the oxygen sulfite reaction can take up to 7 times longer at ph 10.9 than at ph 8.5, ref. 7. Boilerwater ph levels are commonly maintained above ph 10.9.

No perceptible reaction was observed between oxygen and sulfite in the absence of positive catalysts at ph 10.38, ref. 9.

### SUMMARY OF INVENTION

The benefits of this invention are derived from having the main line of defense against oxygen attack moved from boiler internals to the deaerator where kinetics are enhanced in the absence of inhibitors, while reducing or eliminating one or more commonly discharged water and air pollutants.

The greatest value of this invention is gained from its integrated automated response to oxygen excursions with sensors that stoichiometrically quantify sulfite feed rates at all times before damage is allowed to occur within downstream equipment. Downstream equipment includes steaming sections of boilers and condensate piping. These results are achieved without the necessity of total reliance upon high sulfite residuals within boilerwater as a main line of defense against oxygen excursions. High sulfite residuals are additive to deposition problems caused by increased dissolved solids concentrations that result in heat loss, metal failure and sulphide attack in high pressure boiler systems.

### DETAILED DESCRIPTION OF THE INVENTION

Deaerator storage water ph is controlled by a ph sensor within a deaerator's storage section inlet feedwater line, FIG. 1, line 3, interfaced with a caustic feed pump, FIG. 1, line 1, so that a deaerator's influent water flow will be treated with the exact amount of caustic determined by ph signal, FIG. 1, line 3, to maintain ph levels no less than 7.8 and no greater than 8.5.

A ph of 7.8 to 8.5 is required to retain cobalt's II ion in solution at its maximum catalytic value. Otherwise, cobalt will precipitate above ph 8.5. An oxygen sulfite reaction rate catalyzed by cobalt is linearly proportional to the square root of cobalt solution concentration. Therefore, it is important to have cobalt fed and controlled separately at maximum allowable concentrations in a well defined alkaline environment, ref. 4, 18, 20, 21, 22. This separate feeding is opposed to feeding a preestablished fixed ratio within a sulphite cobalt compounded solution which may also be used as an alternate method within the scope of this invention. Cobalt is fed relative to influent water flow through a deaerator. A cobalt catalyst feed pump, FIG. 1, line 4, is interfaced with a flow sensor, FIG. 1, line 2, to adjust the ratio of cobalt dispersed within waters from condensate, FIG. 1, line 13, and deionized makeup water, FIG. 1, line 12.

An oxygen sulfite reaction doubles when cobalt is fed separately of sulfite as compared to its being fed within a compounded sulfite solution, ref. 14, 19, 20, 21, 22.

Sulfite is pump fed, FIG. 1, line 5, on an optional continuous basis to maintain boilerwater residuals from trace to 8 ppm; or as desired, having a pump interfaced with a flow meter, FIG. 1, line 2, and oxygen sensors, FIG. 1, line 6a and sulfite sensors, FIG. 1, line 6b, located in a deaerator's storage section and/or exit line.

Oxygen and sulfite sensors signal a sulfite pump for each increase or decrease of sulfite to quantitatively control the oxygen sulfite reaction with stoichiometry plus low sulfite in trace amounts. This stoichiometric method allows all steam plants an opportunity to install this invention as a fail safe measure even for a plant operating under temperatures above 530° F., ph of 11 and alkalinity of 100 ppm without fear that sulfites will decompose into corrosive sulphides at 8 ppm and above, ref. 6a, 6b, 11.

A ph of 7.8 to 8.5 is necessary because demineralized deaerated water contains molecularly combined carbon dioxide that remains to depress the ph below 7.0. FIG. 2 illustrates that a non-controlled feedwater ph will allow 50% of the only oxygen reactive sulfite specie to be formed, while the remaining bisulfite specie is significantly lost as a reactant in the total amount of chemical that is fed, regardless of the originally fed specie, ref. 9, 18.

When the ph is raised and controlled in the range of 7.8 to 8.5, ninety to ninety five percent of the chemical feed will result in the formation of the only oxygen reactive specie, SOsub.3, FIG. 2. This shift in equilibrium doubles the reactive specie necessary to stoichiometrically satisfy oxygen demand and, at the same time, increases the reaction rate two, 2, fold for every twenty, 20, percent of this specie increase which, in this case, would amount to a reaction rate increase of four to eight fold, ref. 9, 15, 16, 17, 18, 19.

FIG. 1 represents a typical schematic of hydraulic water flow within a deaerator and illustrates the best feeding order of chemicals.

Both cobalt catalyst and sulfite solutions are fed into separate, continuous recirculation lines originating from and to each respective substrate's feed point. This feeding method is used to facilitate precision chemical feeding with immediate dispersion into a substrate, FIG. 3.

### CONCLUSION, RAMIFICATIONS AND SCOPE OF INVENTION

While the above description contains the best method of oxygen scavenging by sulfites within a deaerator, other variations are possible. For example, sulfites may be blended and fed jointly in solution with a cobalt catalyst and still achieve superior results over prior art when the ph is controlled between 7.8 and 8.5 with full use of all sensors previously described. Also, this systemized integration of interfaced sensors can be used with organic as well as inorganic chemicals.

The scope of this invention should be considered in terms or its immediate oxygen responsive technology using oxygen sensors interfaced with other sensors. This immediate sulfite response to oxygen upon demand can be acquired only through the use of interfaced oxygen sensing and chemical pump regulated equipment. These two facets are readily adaptable to other oxygen scavenging reactants.

This invention has been described with respect to participate embodiments thereof. It is apparent that numerous other forms and modifications of this invention will be obvious to those skilled in the art. The appended claims and physicochemical modes of this invention generally should be construed to cover all such obvious forms, methods, modifications and other applicable types of oxygen scavenging chemistries, both volatile and nonvolatile.

Alternate chemistries, other than caustic soda, for pH control are subject to use without affecting the novelty and intended utility of this invention.

### REFERENCES

1. Metcalf, J. H., “Inhibition and Corrosion Control Practices for Boiler Waters”, NACE, Edited by Nathan, C C. pp 196-219 (1973)

2. Harhay, A., Wolfe, C., “Catalytic System Deoxygenates Makeup Water to 10 ppb”, Power Eng., p 24, December (1987)

3. Skaperdas, G. T., Uhlig, H. H., “Corrosion of Steel by Dissolved Carbon Dioxide and Oxygen”, Indust. and Eng. Chem, Vol 34, No. 6, June (1942)

4. Edwards, J. C., Rozas, E. A., “Proceedings of the American Power Conference”, Vol. 23 p 575 (1961)

5. Merriman, W. R., and Phillip, C. T., “New and More Efficient Solution to Water Side Deposits Promised by EDTA”, Power Eng., pp 60-63 Vol. 69, April (1965)

6a. Alexander, R. C., and Rummel, J. K., “Feedwater Treatment during early operation of Steam Electrical Stations”, Trans. ASME, p 531, July (1950)

6b. Taft, W. D., Johnstone, H. F., and Straub, F. G., “Decomposition of Sodium-Sulfite Solutions at Elevated Temperatures”, Trans. ASME, 60; p 261 April (1938).

7. Deev, I. T., “The Corrosion of Water Economizers after Treating the Feedwater with Sulfite” (See #1 Ref. Above, p 205)

8. Arthurs, J., Robins, J. A., Whitefoot, T. B., “Treatment of Water for an Industrial High Pressure Boiler Plant”, Trans. Inst. Chem. Engrs. (London) 37, pp 72-88, (1959)

9. Rand, M. C., Gale, S. B., “Kinetics of the Oxidation of Sulfites by Dissolved Oxygen”, “Principles and Applications of Water Chemistry”, Edited by Faust, S. D. and Junter, J. V., John Wiley and Sons p 380 (1965)

10. Betz Handbook of Industrial Water Conditioning, p 168, 6^{th} Edition.

11. Hitchens, R. M., Purssell, J. W., Jr., “The Behavior of Sodium Sulfite in High Pressure Steam Boilers”, Trans. ASME, pp 469473, August (1938)

12. Laider, K. J., “Chemical Kinetics”, McGraw-Hill, N.Y., pp 339-341, (1950)

13. Twigg, M. V., “Catalyst Handbook”, London; Wolfe (1989)

14. Srivastava, R. D., McMillan, A. F., Harris, I. J., “The Kinetics of Oxidation of Sodium Sulfite”, Canadian Jour. Chem. Eng., Vol. 46, p 181, June (1968)

15. Hayon, E., Treinin, A., Wilf, J., “Electronic Spectra, Photochemistry, and Autoxidation Mechanism of the Sulfite-Bisulfite-Pyrosulfite Systems”, Jour. Am, Chem. Soc., 94:1, pp 47-57, January (1972)

16. Hitchens, R. M., and Towne, R. W., “The Rate of Reaction of Sodium Sulfite with Oxygen Dissolved in Water”, PROC, ASTM, Vol. 36 p 687, (1936)

17. Miron, R. L., “Removal of Aqueous Oxygen by Chemical Means in Oil Production Operations”, Mat. PERF. Vol. 20, No. 6, pp 45-50, June (1981)

18. Fuller, E. C., and Crist, R. H., “The Rate of Oxidation of Sulfite Ions by Oxygen”, Jour. AM. Chem. Soc. Vol. 63, pp 1644-50, June (1941)

19. Chen, Tsung-1 and Barron, C. H., “Some Aspects of the Homogeneous Kinetics of Sulfite Oxidation”, Ind. Eng. Chem. Fund. Vol.11, No. 4, pp 466470 (1972)

20. Bengtsson, S., and Bjerle, I., “Catalytic Oxidation of Sulfite in Diluted Aqueous Solutions”, Chem. Eng. Sci., Vol. 30, pp 1429-35 (1975)

21. De Waal, K. J. A., and Okeson, J. C., “The Oxidation of Aqueous Sodium Sulfite Solutions”, Chem. Engr. Sci, Vol. 21, pp 559-72, (1966)

22. Misra, G. C. and Srivastava, R. D., “Homogeneous Kinetics of Potassium Sulfite Oxidations”, Chem. Eng. Sci., Vol. 31, pp 969-71, December (1976)

23. Filer, Shane and Janick, Mark, “ORP Provides Versatile Water Treatment”, Power Eng., p 56, November (1998)

1. An integrated physicochemical automated kinetic method of rapidly scavenging oxygen within a deaerator's system comprising the steps of:
(a) Installing a variable chemical feed pump as a means of feeding caustic into a deaerator's influent water flow
(b) Installing a water flow sensor as a means of metering combined influent flows of both condensate and makeup water entering a deaerator
(c) Installing a ph sensor as a means of monitoring ph values of water prior to or after exiting a deaerator's downcomer line.
(d) Installing a variable chemical feed pump as a means of feeding catalyst into water prior to exiting a deaerator's downcomer line
(e) Installing a variable chemical feed pump as a means of feeding sulfites or bisulfites or blends of either specie with or without catalytic blending into a deaerator's water storage section and, or downcomer line
(f) Installing a sulfite distribution line as a means of dispersing sulfite within a deaerator's water storage section
(g) Installing a continuously recirculating substrate dilution line as a means of dispersing each chemical into its respective substrate
(h) Installing oxygen and sulfite sensors after sulfite dispersion and sulfite's reaction with oxygen as a means of signaling oxygen and sulfite concentrations that may exist prior to boilerwater influent flow.
(i) Installing an electrical control system, with panel, as a means of integrating all facets of system functions
(j) Interfacing a variable caustic feed pump with a ph sensor through an electrical control panel as a means of variable feeding to control ph between the values 7.8 and 8.5 or greater
(k) Interfacing a water flow rate sensor with a variable catalyst chemical feed pump through an electrical control panel as a means of variable feeding and control of maximum catalyst concentrations as permitted under operating conditions
(l) Interfacing a variable sulfite feed pump with oxygen sensors through an electrical control panel as a means of variable feeding sulfite and control of oxygen at minimum quantities of sulfite to achieve stoichiometrics without excess
(m) Interfacing a variable sulfite and catalyst blended feed pump with an oxygen sensor through an electrical control panel as a means of variable feeding sulfite and control of oxygen at minimum quantities of sulfite to achieve stoichiometrics without excess
